(19) United States
(12) Patent Application Publication
(10) Pub. No.: US 2016/0267878 A1
(43) Pub. Date: Sep. 15, 2016

(54) DISPLAY CONTROL APPARATUS, DISPLAY CONTROL SYSTEM, AND DISPLAY CONTROL METHOD

(71) Applicants: Hiroshi Maeda, Kanagawa (JP); Sachiko Abe, Tokyo (JP)

(72) Inventors: Hiroshi Maeda, Kanagawa (JP); Sachiko Abe, Tokyo (JP)

(73) Assignee: Ricoh Company, Ltd., Tokyo (JP)

(21) Appl. No.: 15/064,547

(22) Filed: Mar. 8, 2016

(30) Foreign Application Priority Data
Mar. 13, 2015 (JP) 2015051233

(51) Int. Cl. G09G 5/12; G06F 3/14

(52) U.S. Cl. CPC G09G 5/12; G06F 3/1446; G09G 2370/02; G09G 2300/026

(57) ABSTRACT

A display control apparatus is connected to another display control apparatus. The display control apparatus includes a display unit configured to display a content; a request reception unit configured to receive a request about the content; a display request generation unit configured to generate a plurality of display requests for controlling display statuses of contents displayed by the display control apparatus and the other display control apparatus synchronously in response to the request, the display requests including a first display request for controlling the display status of the content of the other display control apparatus and a second display request for controlling the display status of the content of the display control apparatus; a communication unit configured to transmit the first display request to the other display control apparatus; and a display control unit configured to control the display status of the content based on the second display request.

### CROSS-REFERENCE TO RELATED APPLICATIONS

The present application is based on and claims the benefit of priority of Japanese Priority Application No. 2015-051233 filed on Mar. 13, 2015 with the Japanese Patent Office, the entire contents of which are hereby incorporated by reference.

### BACKGROUND OF THE INVENTION

1. Field of the Invention

The disclosures herein generally relate to a display control apparatus, a display control system, and a display control method.

2. Description of the Related Art

A multi-projection system which projects, in a big screen, contents transmitted from a personal computer (PC) via a cable such as a wire broadcasting cable and a local area network (LAN) cable using a plurality of projectors is known in the related art. Further, a projector which repeatedly projects contents stored in the projector at predetermined cycles like digital signage without a permanently installed computer is known in the related art.

### SUMMARY OF THE INVENTION

It is a general object of at least one embodiment of the present invention to provide a display control apparatus, a display control system, and a display control method that substantially obviate one or more problems caused by the limitations and disadvantages of the related art.

An embodiment of the present invention provides a display control apparatus connected to another display control apparatus. The display control apparatus includes a display unit configured to display a content; a request reception unit configured to receive a request about the content displayed by the display unit; a display request generation unit configured to generate a plurality of display requests for controlling, in synchronization with each other, display statuses of contents displayed by the display control apparatus and the other display control apparatus in response to the request received by the request reception unit, the plurality of display requests including a first display request for controlling the display status of the content displayed by the other display control apparatus and a second display request for controlling the display status of the content displayed by the display control apparatus; a communication unit configured to transmit the first display request to the other display control apparatus; and a display control unit configured to control the display status of the content displayed by the display unit based on the second display request.

### BRIEF DESCRIPTION OF THE DRAWINGS

FIG. 1 is a schematic diagram illustrating an example of a display control system according to a first embodiment;

FIG. 2 is a block diagram illustrating an example of a functional configuration of a projector according to the first embodiment;

FIG. 3 is a block diagram illustrating an example of a hardware configuration of the projector according to the first embodiment;

FIG. 4 is a sequence chart illustrating an example of a temporary stopping process according to the first embodiment;

FIG. 5 is a conceptual diagram of the temporary stopping process according to the first embodiment;

FIG. 6 is a block diagram illustrating an example of a functional configuration of a projector according to a second embodiment;

FIG. 7 is a flowchart illustrating an example of a communication time obtaining process according to the second embodiment;

FIG. 8 is a sequence chart illustrating an example of a reproduction process according to the second embodiment;

FIG. 9 is a conceptual diagram of the reproduction process according to the second embodiment;

FIG. 10 is a flowchart illustrating an example of the temporary stopping process according to the second embodiment;

FIG. 11 is a conceptual diagram of the temporary stopping process according to the second embodiment;

FIG. 12 is a flowchart illustrating an example of the reproduction process in a case in which reproduction timing is designated;

FIG. 13 is a conceptual diagram of a fast-forwarding reproduction process according to the second embodiment;

FIG. 14 is a conceptual diagram of the temporary stopping process using a playlist according to the second embodiment; and

FIG. 15 is a conceptual diagram of a stopping process according to the second embodiment; and

FIG. 16 is a list of timing information.

### DESCRIPTION OF THE PREFERRED EMBODIMENTS

In the following, embodiments of the present invention will be described with reference to the accompanying drawings.

### First Embodiment

### Schematic Configuration of a Display Control System 1

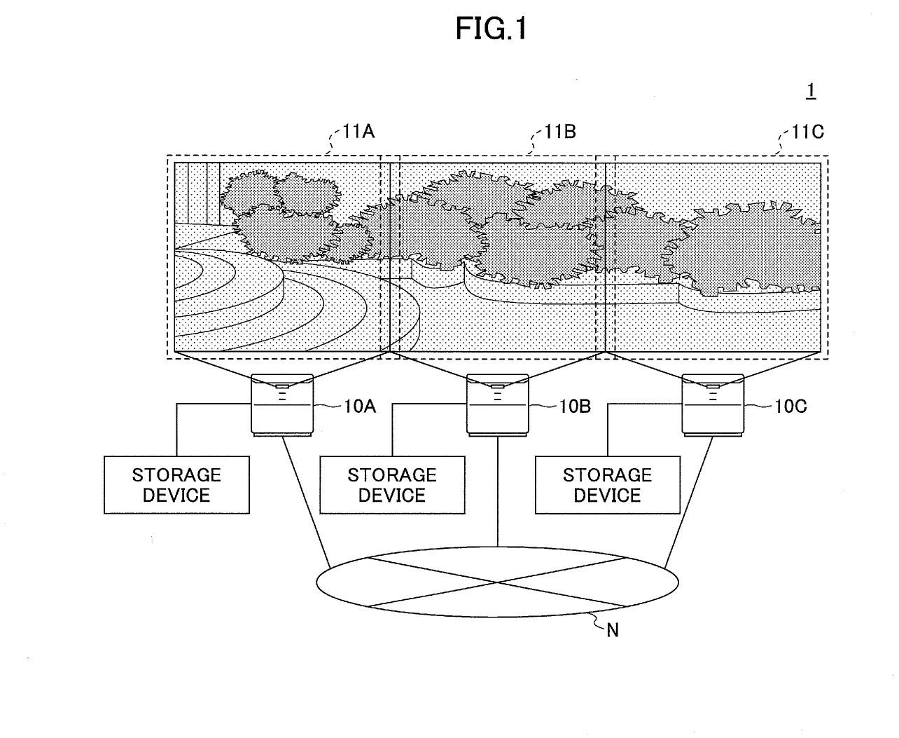

FIG. 1 is a schematic diagram illustrating an example of a display control system 1 according to a first embodiment. The display control system 1 shown in FIG. 1 includes projectors 10A, 10B, and 10C (in the following, referred to as “the projector 10” or “the projectors 10” as appropriate) as examples of display control apparatuses. The projectors 10A to 10C are connected to a network N such as the Internet and a local area network (LAN) in order to transmit and receive data with each other. It should be noted that the projector 10 is an example of a display control apparatus. It should be noted that the number of projectors 10 shown in FIG. 1 is not limited to this.

The projectors 10A to 10C are connected to respective storage devices such as universal serial bus (USB) memories, and project respective contents, which are stored in the storage devices, on predetermined screens. Although a video image (image frames switched at predetermined time intervals) may be displayed as an example of the content, the content to be displayed is not limited to this. It should be noted that the storage device, which stores (holds) the content, is not limited to the USB memory. For example, a memory built in the projector 10 or an external server may be used as the storage device.

For example, the contents displayed by the projectors 10A to 10C are divided such that the projectors 10A to 10C project the respective divided contents in order to form one content. In the example shown in FIG. 1, the projector 10A holds a content 11A, the projector 10B holds a content 11B, and the projector 10C holds a content 11C. It should be noted that time information such as a time stamp is set for each of the contents 11A to 11C. The projectors 10A to 10C can output (project) the video images which correspond to times of frame images.

### Functional Configuration of the Projector 10

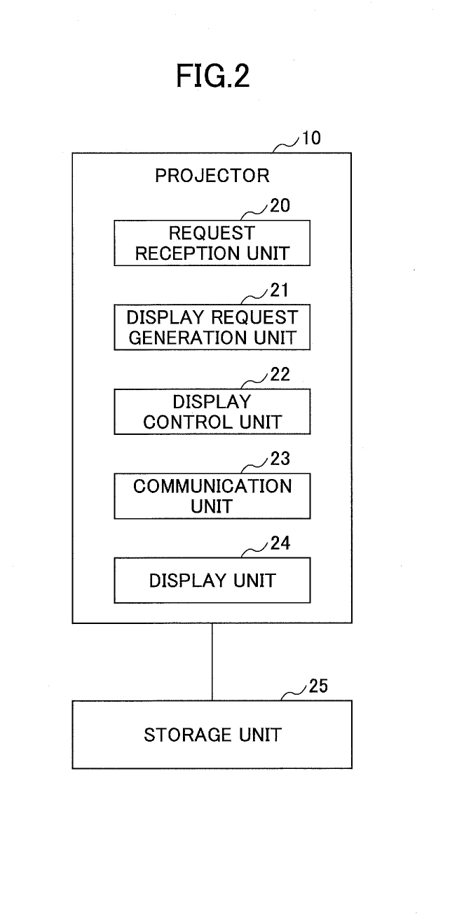

FIG. 2 is a block diagram illustrating an example of a functional configuration of the projector 10 according to the first embodiment. It should be noted that each of the above described projectors 10A to 10C may have the same configuration. As shown in FIG. 2, the projector 10 includes a request reception unit 20, a display request generation unit 21, a display control unit 22, a communication unit 23, a display unit 24, and a storage unit 25.

The request reception unit 20 receives a request from a user. For example, the request from the user may be a request for stopping the displayed content temporarily, a request for reproducing the content (including a restart from a display timing (display time) of the temporarily stopped content or the stopped content), or a request for executing fast-forwarding or rewinding. It should be noted that the “fast-forwarding” may include a “fast-forwarding reproduction” in which the content is being displayed in the screen or the like while executing the fast-forwarding. Further, the “rewinding” may include a “rewinding reproduction” in which the content is being displayed in the screen or the like while executing the rewinding.

The display request generation unit 21 generates a plurality of display requests in response to the request received by the request reception unit 20. The display requests are requests for controlling displaying statuses (reproduction statuses) of the contents displayed by the projectors 10A to 10C synchronously. The projectors 10A to 10C form a big screen such as a multi-projection. For example, the display requests may include a first display request for controlling a display content displayed by another projector 10 and a second display request for controlling a display content displayed by own projector 10. It should be noted that the display requests are not limited to these.

The display request generation unit 21 may determine, for example, display timing of the content (such as temporary stopping timing) based on current display timing of the content such that the projectors 10A to 10C display the contents in synchronization with each other. Each of the display requests may include the determined display timing. It should be noted that the display request generation unit 21 can grasp the number of projectors 10 and a type of the projectors 10 by holding (storing) group information of the projectors 10 which form the big screen before starting the multi-projection.

The display control unit 22 controls the display unit 24 such that the display unit 24 displays the content based on the display request generated by the display request generation unit 21. For example, the display control unit 22 causes the display unit 24 to display the content based on the display request such as the request of the display timing of the content, and the request for stopping temporarily, reproducing, fast-forwarding, or rewinding the content.

The communication unit 23 holds information of IP addresses of other projectors 10 and the like as the group information before starting the multi-projection, and transmits/receives data to/from the other projectors 10. For example, the communication unit 23 transmits the data to each of the other projectors 10 in response to obtaining the display request from the display request generation unit 21.

Based on the request of the display control unit 22, the display unit 24 obtains the content from the storage unit 25 in order to display the content. It should be noted that the display unit 24 may display the content on a predetermined position such as a predetermined screen and a wall, and a display.

The storage unit 25 may be a USB memory and the like. The storage unit 25 stores the content displayed by the display unit 24. It should be noted the storage unit 25 may be built in the projector 10.

### Hardware Configuration of the Projector 10

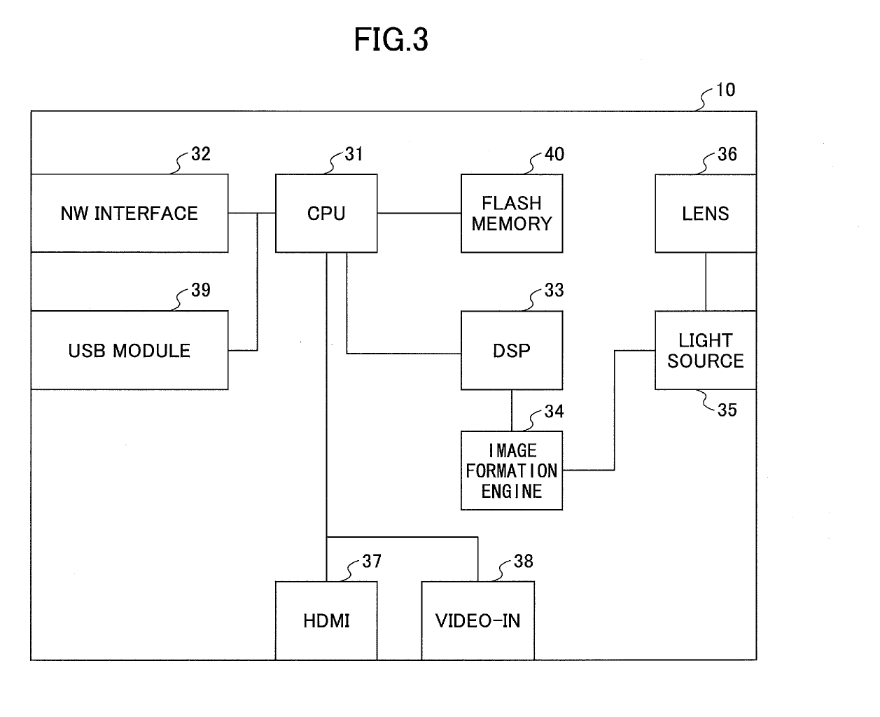

FIG. 3 is a block diagram illustrating an example of a hardware configuration of the projector 10 according to the first embodiment. As shown in FIG. 3, the projector 10 includes a central processing unit (CPU) 31, a network (NW) interface 32, a digital signal processor (DSP) 33, an image formation engine 34, a light source 35, a lens 36, a HDMI 37, a VIDEO-IN 38, a USB module 39, and a flash memory 40.

The CPU 31 controls the entire operation of the projector 10. For example, the CPU 31 controls execution of the processes such as the generation of the display request by the display request generation unit 21, the display control by the display control unit 22, the communication control by the communication unit 23, and the displaying by the display unit 24. It should be noted that the control executed by the CPU 31 is not limited to this. The CPU 31 may control starting and finishing of a process according to a display control program of the first embodiment, and a process when an error occurs. Further, the CPU 31 can control time and the like by using an internal timer (system clock) provided in the projector 10.

The NW interface 32 is, for example, a wireless module such as a communication unit which performs network communication with the other projectors 10. The NW interface 32 is not limited to the wireless module. A wired module or a module which can perform both the wireless communication and the wired communication may be used as the NW interface 32. By using the NW interface 32, the projector 10 can transmit/receive the data to/from another apparatus (the other projector(s) 10) via the network N.

The DSP 33 processes the data obtained from the CPU 31. For example, the DSP 33 can perform image processing at high speed for the video image. The content obtained by the CPU 31 and the DSP 33 is formed into a projectable video image by the image formation engine 34. The formed video image is projected on the predetermined position (such as the screen and the wall) by the light source 35 and the lens 36 in a predetermined size.

The HDMI (registered trademark) 37 and the VIDEO-IN 38 are input units which input the video image from an outside via a cable or the like. It should be noted that a type of the input unit, which inputs the video image, is not limited to this.

The USB module 39 can be detachably connected to a USB memory or the like. The USB module 39 can read the data and write the data by communicating with the USB memory or the like. The flash memory 40 is a storage unit which stores various data and programs.

### Sequence of a Temporary Stopping Process

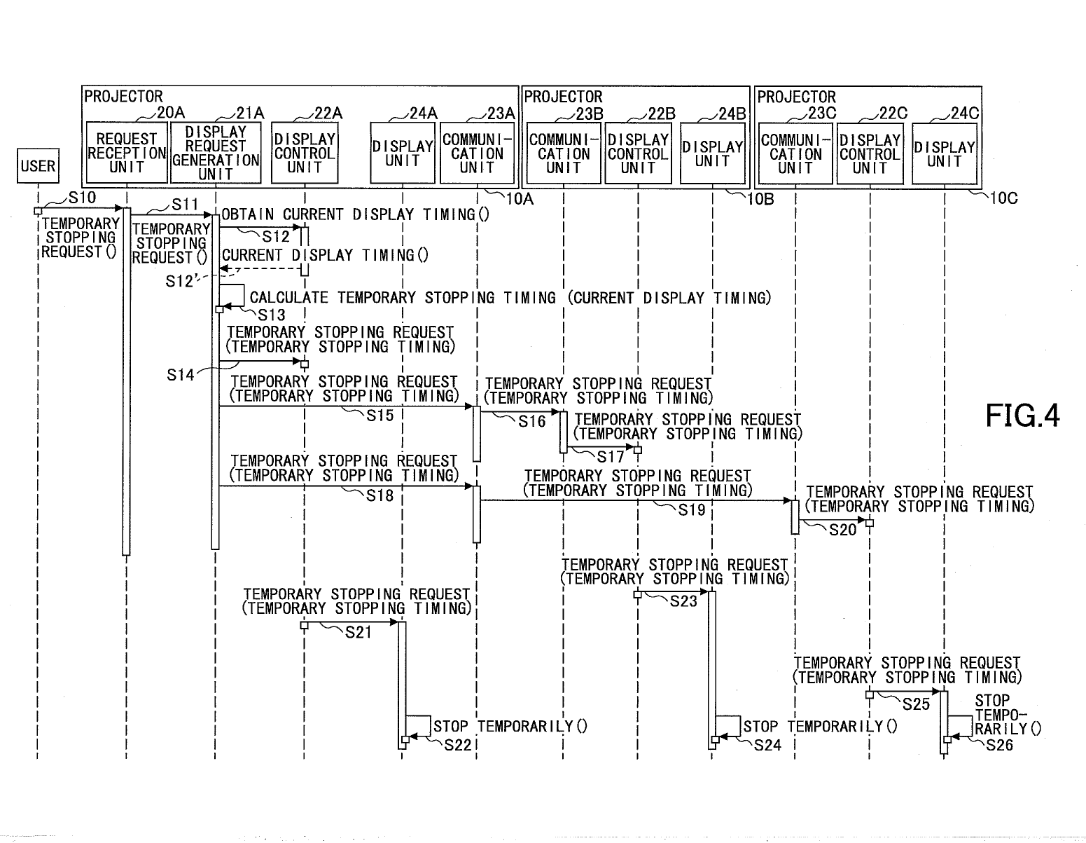

FIG. 4 is a sequence chart illustrating an example of the temporary stopping process (process for stopping the content temporarily) according to the first embodiment. In the example shown in FIG. 4, in response to an event in which the projector 10A (one of the projectors 10 forming the multi-projection) receives, from the user, a temporary stopping request for stopping temporarily the moving images (video images) being reproduced (projected), the projector 10A controls the moving image of the projector 10A to stop temporarily at a display timing after a predetermined timing passes from the current display timing. Further, the projector 10A (one of the projectors 10) performs display control such that the moving images (contents) of the projectors 10B and 10C (other projectors 10) are temporarily stopped in synchronization with the moving image of the projector 10A.

The sequence shown in FIG. 4 is executed by the projectors 10A to 10C. It should be noted that some elements are omitted as appropriate in the example shown in FIG. 4 for convenience of description. In the example shown in FIG. 4, the request reception unit 20A, the display request generation unit 21A, the display control unit 22A, the display unit 24A, and the communication unit 23A are indicated in the projector 10A. Further, the display control units 22B and 22C, the communication units 23B and 23C, and the display units 24B and 24C are indicated in the projectors 10B and 10C, respectively.

As shown in FIG. 4, in response to an event in which the request reception unit 20A receives, from the user, the temporary stopping request for stopping temporarily the moving images being reproduced in step S10, the projector 10A transmits the temporary stopping request to the display request generation unit 21A in step S11. In steps S12 and S12′, the projector 10A causes the display request generation unit 21A to transmit, to the display control unit 22A, an obtaining request for obtaining the current display timing of the moving image being reproduced. In step S13, the projector 10A calculates the temporary stopping timing in which the moving image is stopped after the predetermined timing passes from the current display timing (for example, after 3 seconds from the current display timing).

In step S14, the projector 10A causes the display request generation unit 21A to transmit, to the display control unit 22A, the temporary stopping request (second display request) which includes information of the temporary stopping timing obtained in step S13. Further, in steps S15 and S16, the projector 10A causes the display request generation unit 21A to transmit, to the projector 10B via the communication unit 23A, the temporary stopping request (first display request) which includes the information of the temporary stopping timing obtained in step S13.

In response to receiving the temporary stopping request from the projector 10A via the communication unit 23B in step S16, the projector 10B causes the communication unit 23B to transmit the temporary stopping request to the display control unit 22B in step S17. Similarly, in steps S18 and S19, the projector 10A causes the display request generation unit 21A to transmit, to the projector 10C via the communication unit 23A, the temporary stopping request (first display request) which includes the information of the temporary stopping timing obtained in step S13. In response to receiving the temporary stopping from the projector 10A in step S19, the projector 10C causes the communication unit 23C to transmit the temporary stopping request to the display control unit 22C in step S20.

When the projector 10A causes the display control unit 22A to transmit the temporary stopping request to the display unit 24A in step S21, the projector 10A causes the display unit 24A to stop temporarily the moving image being reproduced in step S22. Similarly, when the projector 10B causes the display control unit 22B to transmit the temporary stopping request to the display unit 24B in step S23, the projector 10B causes the display unit 24B to stop temporarily the moving image being reproduced in step S24. Similarly, when the projector 10C causes the display control unit 22C to transmit the temporary stopping request to the display unit 24C in step S25, the projector 10C causes the display unit 24C to stop temporarily the moving image being reproduced in step S26.

In the above described example shown in FIG. 4, a temporary stopping process in steps S22, S24, and S26 for stopping the moving images temporarily is executed at the same time based on the information of the temporary stopping timings included in the corresponding temporary stopping requests. Thus, the display timings of the contents stopped temporarily are synchronized in the projectors 10A to 10C.

Because the stopped time uses time information of the time stamp added to each of the contents, the synchronized video images are stopped temporarily.

### Conceptual Diagram of the Temporary Stopping Process

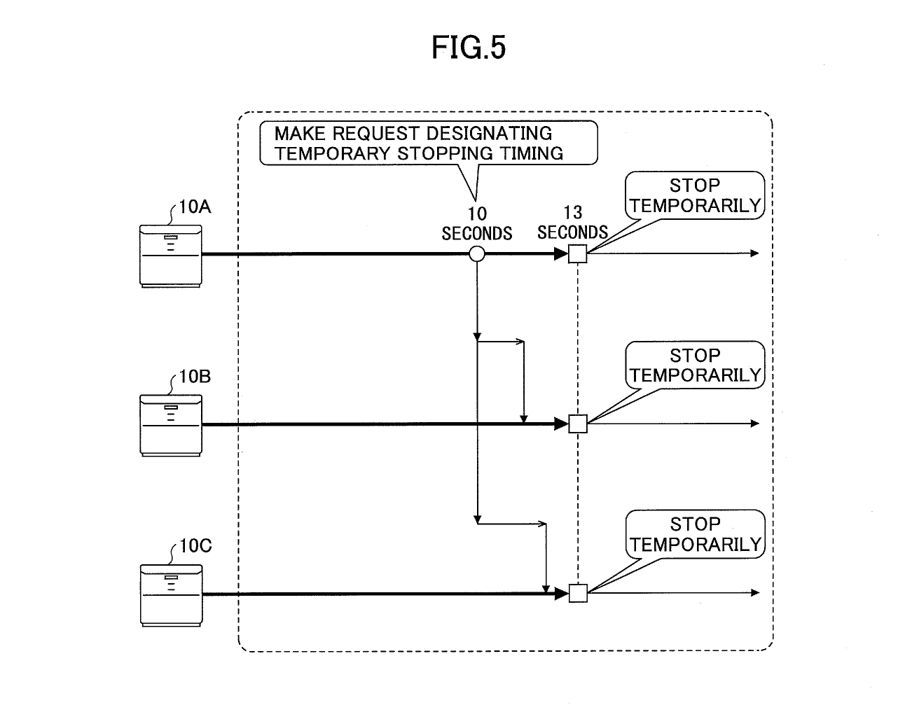

FIG. 5 is a conceptual diagram of the temporary stopping process according to the first embodiment. In the example shown in FIG. 5, a case in which the projector 10A receives the temporary stopping request from the user when the current display timing of the moving image (content) being displayed is “10 seconds” will be described.

As shown in FIG. 5, when the projector 10A determines that the current display timing of the moving image, for which the temporary stopping request is made from the user, is 10 seconds, the projector 10A determines that the display timing (temporary stopping timing) after passing the predetermined timing (in this example, after 3 seconds from the current display timing) is 13 seconds.

Next, the projector 10A requests the own display control unit 22A to temporarily stop the moving image at the designated temporary stopping timing (display timing after passing 13 seconds from the start). Further, the projector 10A requests the other projectors 10B and 10C included in the group information to stop at the designated temporary stopping timing (display timing after passing 13 seconds from the start).

As described above, the projectors 10, which form the big screen of the multi-projection, can cooperate (communicate) with each other in order to stop the moving images at the temporary stopping timing (display timing after passing 13 seconds from the start) synchronously respond to the temporary stopping request from the user. It should be noted that a value of the above described predetermined timing (3 seconds) may be set previously. However, the present invention is not limited to this. For example, the user may designate timing when instructing (making) the temporary stopping request. Further, timing may be changed in accordance with a reproduction speed of the moving images (video images) when instructed, and/or the number or type of projectors 10 to be synchronized.

### Second Embodiment

### Functional Configuration of the Projector 10′

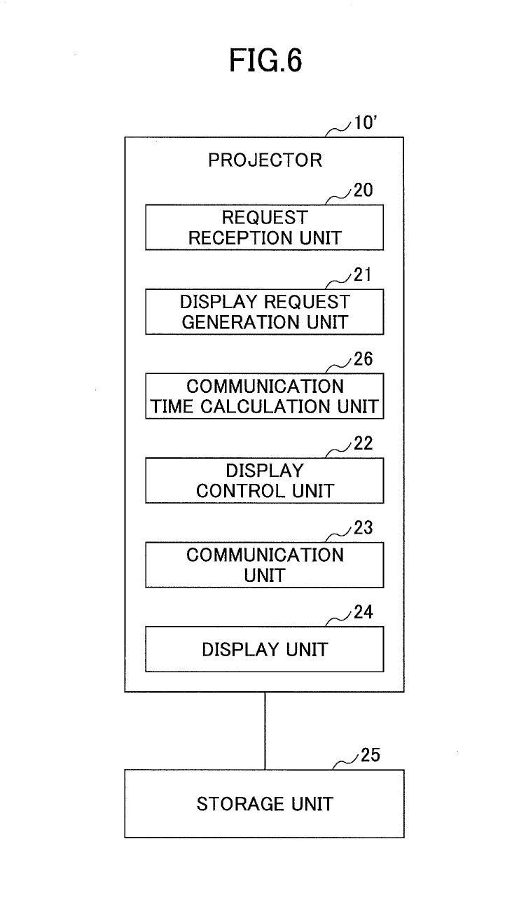

FIG. 6 is a block diagram illustrating an example of a functional configuration of the projector 10′ according to the second embodiment. In the second embodiment, communication times (time required for communicating) between the projectors 10′ are obtained and the contents are displayed synchronously based on the communication times.

As shown in FIG. 6, the projector 10′ includes the request reception unit 20, the display request generation unit 21, the display control unit 22, the communication unit 23, the display unit 24, the storage unit 25, and a communication time calculation unit 26.

It should be noted that the second embodiment shown in FIG. 6 differs from the first embodiment shown in FIG. 2 in that the projector 10′ includes the communication time calculation unit 26. Thus, elements of the second embodiment similar to the elements of the first embodiment are referred to as the same reference signs and their descriptions will be omitted as appropriate.

For example, the communication time calculation unit 26 calculates communication time when starting the multi-projection or in predetermined timings (at fixed intervals). The communication time calculation unit 26 issues an IP packet to another projector 10′, which forms the multi-projection and is included in the group information, and obtains transmission/reception time of the IP packet. The IP packet includes a predetermined command such as a Ping command. In this way, the communication time calculation unit 26 obtains the communication time between the own projector 10′ and the other projector 10′.

In accordance with the obtained communication time, display requests are made to each of the projectors 10′ in the second embodiment. In this way, in the second embodiment, display control can be executed at the same timing (synchronously) in consideration of a delay of the communication via the network N.

### Communication Time Obtaining Process

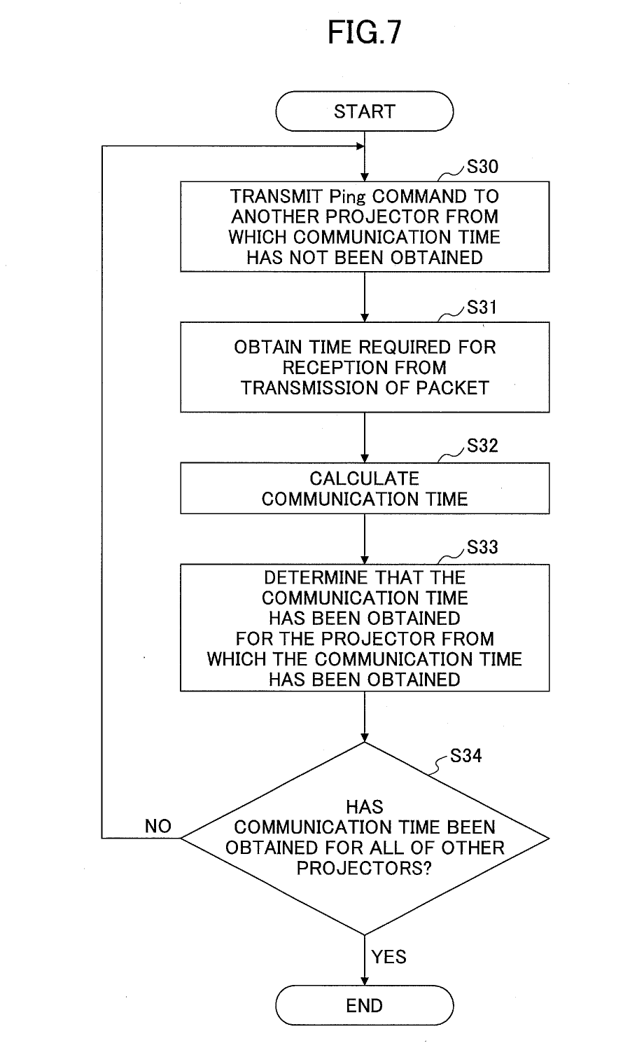

FIG. 7 is a flowchart illustrating an example of the communication time obtaining process (process for obtaining the communication time) according to the second embodiment. As shown in FIG. 7, in step S30, the own projector 10′ transmits, to the other projector 10′ from which the communication time has not been obtained by the communication time calculation unit 26, the IP packet such as the Ping command in order to obtain the communication time between the own projector 10′ and the other projector 10′. It is preferable that the process in step S30 is performed when starting the multi-projection or performed in the predetermined timings (at fixed intervals).

Next, after obtaining time (period of time) required for receiving the IP packet from the transmission of the IP packet in step S31, the communication time calculation unit 26 calculates the communication time in step S32. Next, after determining in step S33 that the communication time has been obtained for the other projector 10′, from which the communication time has been obtained, the communication time calculation unit 26 determines in step S34 whether communication time has been obtained for all of the other projectors 10′.

When the communication time calculation unit 26 determines that the communication time has been obtained for all of the other projectors 10′ (YES in step S34), the communication time calculation unit 26 finishes the process. It should be noted that when the communication time calculation unit 26 determines that the communication time has not been obtained for all of the other projectors 10′ (NO in step S34), the process returns to step S30.

### Sequence of a Reproduction Process

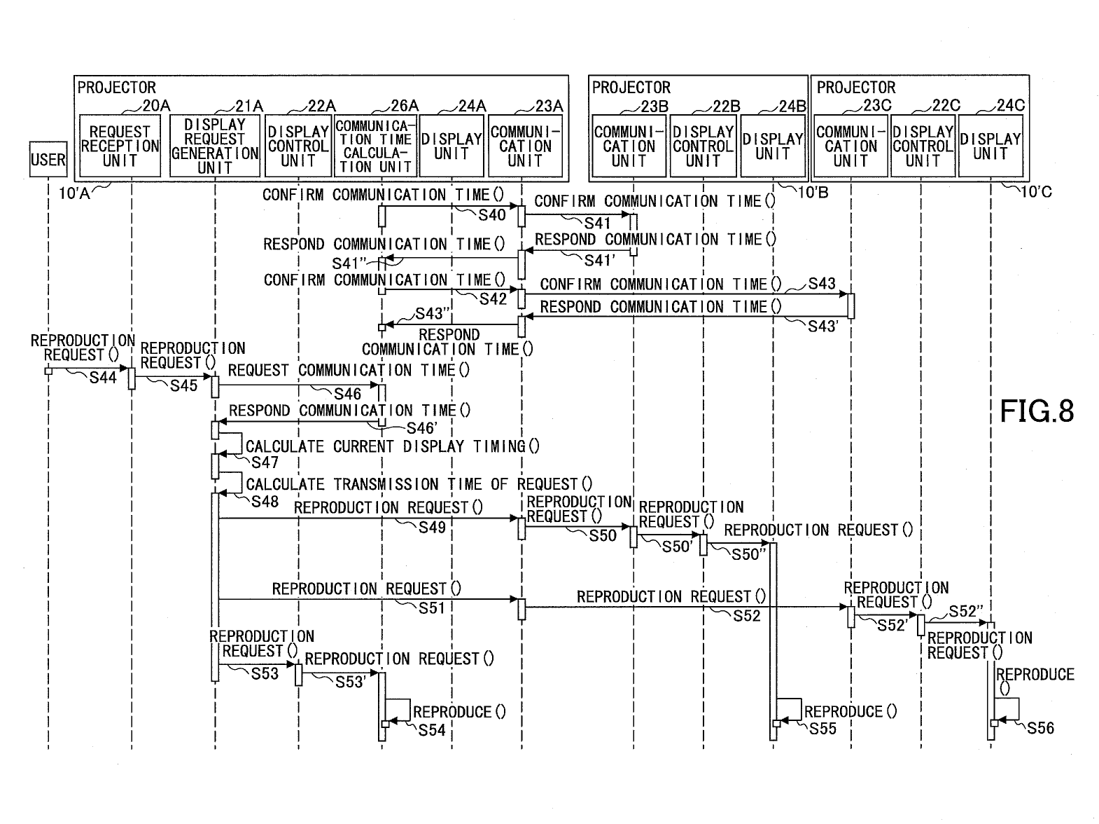

FIG. 8 is a sequence chart illustrating an example of the reproduction process (process for reproducing the moving images) according to the second embodiment. In the example shown in FIG. 8, the projector 10A (one of the projectors 10′ forming the multi-projection) previously obtains the communication times with the other projectors 10′B and 10′C, and performs display control such that the projectors 10′A to 10′C reproduce the moving images at the same timing in response to an event in which the projector 10′A receives the reproduction request for reproducing the moving images being reproduced from the user.

The sequence shown in FIG. 8 is executed by the projectors 10′A to 10′C. It should be noted that some elements are omitted as appropriate in the example shown in FIG. 8 for convenience of description. In FIG. 8, the request reception unit 20A, the display request generation unit 21A, the display control unit 22A, the display unit 24A, the communication unit 23A, and the communication time calculation unit 26A are indicated in the projector 10′A. Further, the display control units 22B and 22C, the communication units 23B and 23C, and the display units 24B and 24C are indicated in the projectors 10′B and 10′C, respectively.

As shown in FIG. 8, the projector 10′A causes the communication time calculation unit 26A to transmit, to the projector 10′B via the communication unit 23A, a communication time confirmation request for confirming the communication time in steps S40 and S41. In response to receiving the communication time confirmation request via the communication unit 23B in step S41, the projector 10′B returns (transmits) a confirmation response of the communication time to the projector 10′A in steps S41′ and S41″.

Similarly, the projector 10′A causes the communication time calculation unit 26A to transmit, to the projector 10′C via the communication unit 23A, the communication time confirmation request for confirming the communication time in steps S42 and S43. In response to receiving the communication time confirmation request via the communication unit 23C in step S43, the projector 10′C returns a confirmation response of the communication time to the projector 10′A in steps S43′ and S43″.

It should be noted that the projector 10′A executes the process in steps S40 to S43 at fixed intervals in order to update information of the communication time(s). In this way, the display control can be performed at the proper timing based on the regularly updated communication time if communication time differs according to time.

In response to an event in which the request reception unit 20A receives, from the user, the reproduction request for reproducing the moving images in step S44, the projector 10′A transmits the reproduction request to the display request generation unit 21A in step S45. In steps S46 and S46′, the projector 10′A causes the display request generation unit 21A to transmit, to the communication time calculation unit 26A, an obtaining request for obtaining the communication time, and obtains the communication times between the projector 10′A and the other projectors 10′B and 10′C.

Next, the projector 10′A causes the display request generation unit 21A to calculate the current display timing in step S47. In step S48, the display request generation unit 21A calculates time (transmission time of the request) when the reproduction request is output to each of the projectors 10′. In the process in step S48, the display request generation unit 21A may calculate the transmission time of the request for each of the projectors 10′, for example, based on the longest communication time required for communicating with the other projector 10′ among the communication times required for communicating with the other projectors 10′.

Next, in steps S49 and S50, the projector 10′A causes the display request generation unit 21A to transmit, to the projector 10′B via the communication unit 23A, the reproduction request based on the transmission time of the request obtained in the process in step S48. In response to receiving the reproduction request from the projector 10′A via the communication unit 23B in step S50, the projector 10′B causes the communication unit 23B to transmit the reproduction request to the display control unit 22B in step S50′, and causes the display control unit 22B to transmit the reproduction request to the display unit 24B in step S50″.

Further, in steps S51 and S52, the projector 10′A causes the display request generation unit 21A to transmit, to the projector 10′C via the communication unit 23A, the reproduction request based on transmission time of the request obtained in the process in step S48. In response to receiving the reproduction request from the projector 10′A via the communication unit 23C in step S52, the projector 10′C causes the communication unit 23C to transmit the reproduction request to the display control unit 22C in step S52′, and causes the display control unit 22C to transmit the reproduction request to the display unit 24C in step S52″.

Further, when the projector 10′A causes the display request generation unit 21A to transmit, to the display control unit 22A in step S53, the reproduction request based on the transmission time of the request obtained in the process in step S48, the projector 10′A causes the display control unit 22A to transmit the reproduction request to the display unit 24A in step S53′.

In this way, the projectors 10′ can reproduce the moving images at the same time. That is, the projector 10′A causes the display unit 24A to reproduce the corresponding moving image in step S54. The projector 10′B causes the display unit 24B to reproduce the corresponding moving image in step S55. The projector 10′C causes the display unit 24C to reproduce the corresponding moving image in step S56.

It should be noted that although the projector 10′A obtains the communication times from the projector 10′B and 10′C in the example shown in FIG. 8, it is preferable that each of the projectors 10′, which form the multi-projection, obtains the communication times. In this way, any one of the projectors 10′A to 10′C from which the user instructs can transmit, to the other projectors 10′, the reproduction request at the proper timing.

### Conceptual Diagram of the Reproduction Process

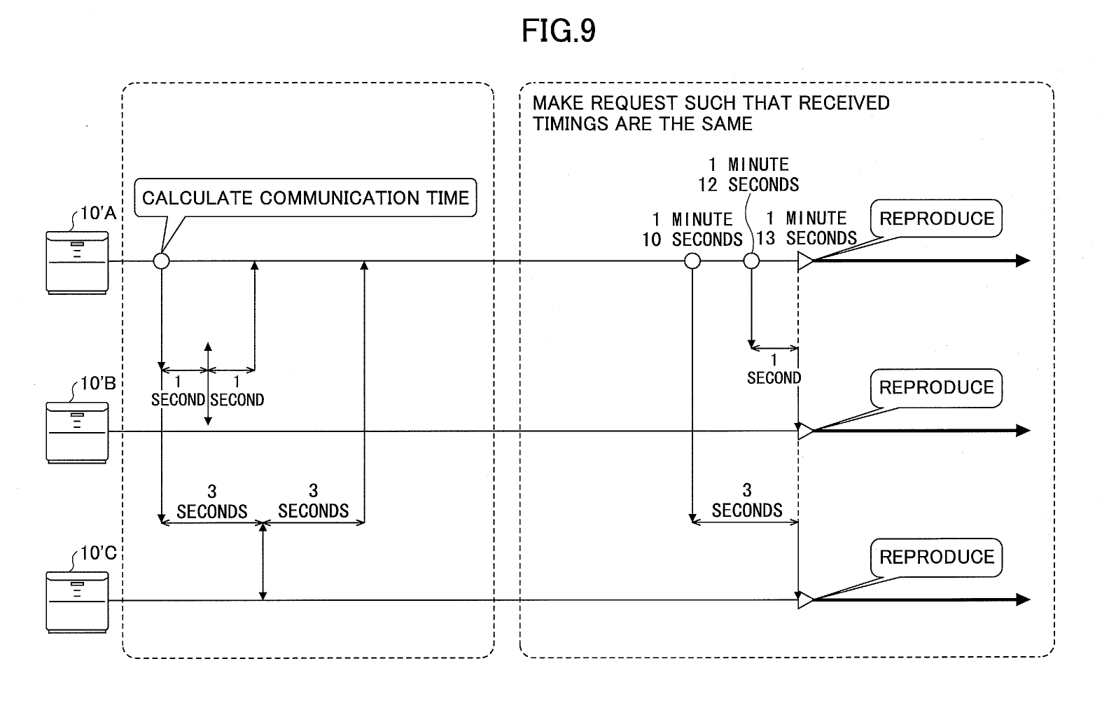

FIG. 9 is a conceptual diagram of the reproduction process according to the second embodiment. In the example shown in FIG. 9, the projector 10′A (one of the projectors 10′ forming the multi-projection) previously obtains the communication times with the other projectors 10′B and 10′C, and performs display control such that the projectors 10′A to 10′C reproduce the moving images at the same timing in response to an event in which the projector 10′A receives the reproduction request for reproducing the moving images being reproduced from the user.

As shown in FIG. 9, the projector 10′A calculates the communication time with the projector 10′B as “1 second” and calculates the communication time with the projector 10′C as “3 seconds”. As described above, it is preferable that the projector 10′A calculates the communication times with the other projectors 10′B and 10′C previously or at fixed intervals. In other words, it is preferable that the projector 10′A calculates the communication times with the other projectors 10′B and 10′C before executing processes such as the reproduction process.

In response to receiving the reproduction request for reproducing the moving images from the user, the projector 10′A causes the display request generation unit 21A to confirm the display timing when the reproduction request is received (current display timing is 1 minute 10 seconds). Further, based on the communication times calculated previously, the projector 10′A causes the display request generation unit 21A to transmit the reproduction requests to the projectors 10′B and 10′C such that the projectors 10′B and 10′C receive the reproduction requests at the same timing.

In the example shown in FIG. 9, based on the communication time “3 seconds” with the projector 10′C, which is the longest communication time required for communicating, and the current display timing (1 minute 10 seconds), the projector 10′A outputs the reproduction requests such that the timings at which the projectors 10′B and 10′C receive the respective reproduction requests are the same timing (1 minute 13 seconds).

That is, in the example shown in FIG. 9, the projector 10′A transmits the reproduction request to the projector 10′C at the timing “1 minute 10 seconds” because the communication time with the projector 10′C requires “3 seconds”. Further, the projector 10′A transmits the reproduction request to the projector 10′B at the timing “1 minute 12 seconds” because the communication time with the projector 10′B requires “1 second”. Further, the projector 10′A performs the own reproduction at the timing “1 minute 13 seconds”.

In this way, the projectors 10′A to 10′C can reproduce the moving images at the same time. It should be noted that although the projector 10A′ performs the display control in the above described example, the projector 10′B (or 10′C) may perform the display control.

### Flowchart of the Temporary Stopping Process

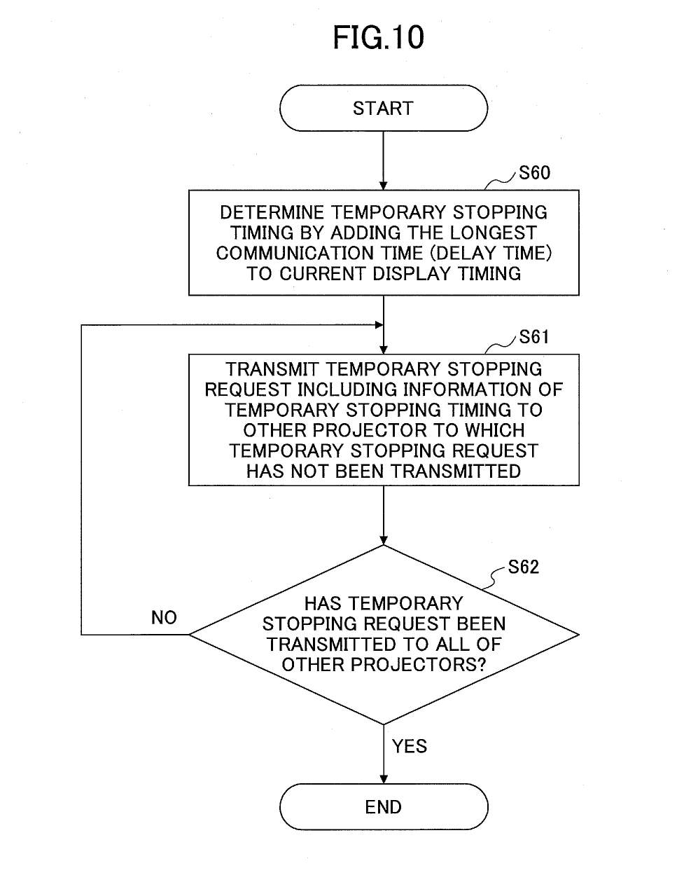

FIG. 10 is a flowchart illustrating an example the temporary stopping process according to the second embodiment. In the example shown in FIG.

10, the projector 10′A, which previously obtains the communication times with the other projectors 10′B and 10′C, performs display control such that the projectors 10′A to 10′C stop the moving images at the same timing in response to an event in which the projector 10′A receives the temporary stopping request for temporarily stopping the moving images being reproduced from the user.

As shown in FIG. 10, in response to receiving, from the user, the temporary stopping request for stopping the moving images temporarily, the projector 10′ causes the display request generation unit 21 to add the previously obtained longest communication time (delay time) among the communication times required for communicating with the other projectors 10′ to the current display timing in order to determine the temporary stopping timing in step S60.

In step S61, the projector 10′ transmits, via the communication unit 23, the temporary stopping request to one of the other projectors 10′ to which the temporary stopping request has not been transmitted. The temporary stopping request includes information of the temporary stopping timing determined in the process in step S60. In step S62, the projector 10′ determines whether the temporary stopping request has been transmitted to all of the other projectors 10′.

In a case in which the projector 10′ determines that the temporary stopping request has not been transmitted to all of the other projectors 10′ (NO in step S62), the process returns to step S61 to continue. In a case in which the projector 10′ determines that the temporary stopping request has been transmitted to all of the other projectors 10′ (YES in step S62), the process ends.

### Conceptual Diagram of the Temporary Stopping Process

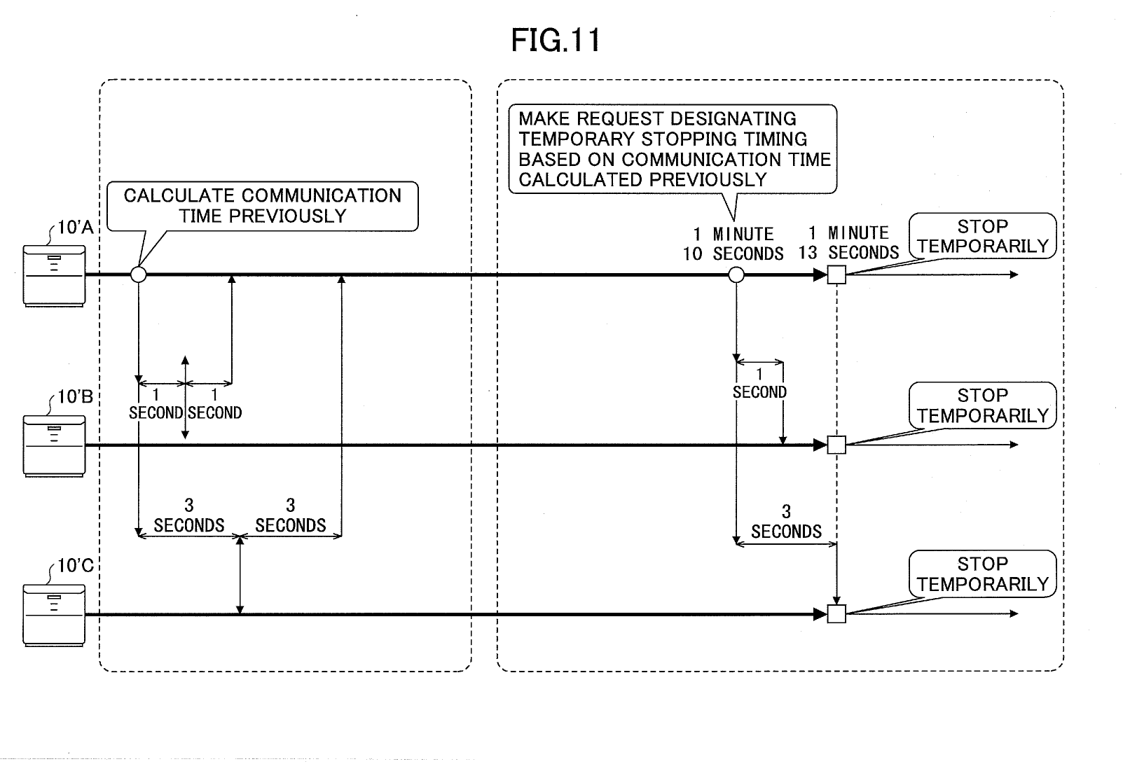

FIG. 11 is a conceptual diagram of the temporary stopping processes according to the second embodiment. In the example shown in FIG. 11, the projector 10′A (one of the projectors 10′ forming the multi-projection) previously obtains the communication times with the other projectors 10′B and 10′C, and performs display control such that the projectors 10′A to 10′C stop the moving images at the same timing in response to an event in which the projector 10′A receives the temporary stopping request for temporarily stopping the moving images from the user.

As shown in FIG. 11, the projector 10′A previously calculates the communication time with the projector 10′B as “1 second”, and calculates the communication time with the projector 10′C as “3 seconds”. In response to receiving the temporary stopping request for stopping the moving images temporarily from the user, the projector 10′A confirms the display timing when the temporary stopping request is received (current display timing is 1 minute 10 seconds).

When the projector 10′A transmits the temporary stopping request at the current display timing (1 minute 10 seconds), the communication time with the projector 10′C requires at most 3 seconds. Thus, the projector 10′A determines the temporary stopping timing (1 minute 13 seconds) based on the delay time (longest communication time), and transmits the temporary stopping requests to the projectors 10′B and 10′C while designating the temporary stopping timing.

### Flowchart of the Reproduction Process in a Case in which the Reproduction Timing is Designated

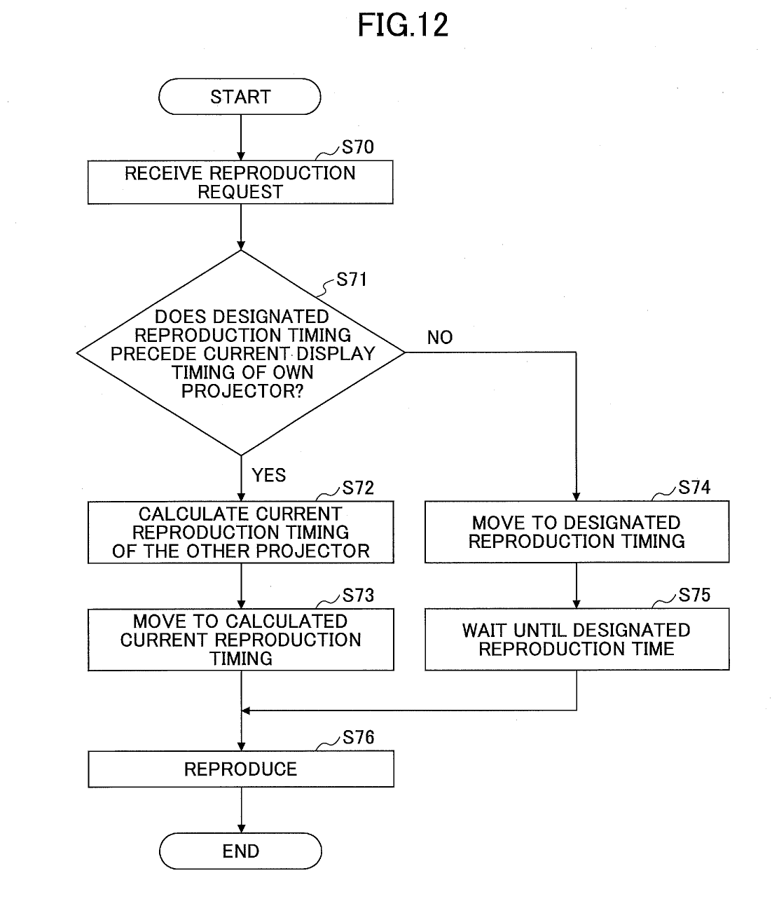

FIG. 12 is a flowchart illustrating an example of the reproduction process in a case in which the reproduction timing is designated. In the example shown in FIG. 12, in a case in which the reproduction timing (display timing of the content) when the moving image is to be reproduced is designated in the reproduction request of the moving image which is received from the other projector 10′, the own projector 10′ is controlled to reproduce the moving image at the designated reproduction timing synchronously.

As shown in FIG. 12, in response to receiving in step S70, from the other projector 10′, the reproduction request in which the reproduction timing is designated, the own projector 10′ causes the display control unit 22 to determine whether the reproduction timing designated in the request precedes the current display timing of the own projector 10′ in step S71.

In a case in which the display control unit 22 determines that the designated reproduction timing precedes the current display timing of the own projector 10′ (the designated reproduction timing is before the current display timing of the own projector 10′) (YES in step S71), the own projector 10′ calculates (obtains) in step S72 the current reproduction timing (current display timing) of the other projector 10′ which has transmitted the reproduction request. Next, in step S73, the own projector 10′ instructs the display unit 24 to move to the current reproduction timing of the other projector 10′ calculated in the process in step S72.

Further, in a case in which the display control unit 22 determines that the designated reproduction timing does not precede the current display timing of the own projector 10′ (the designated reproduction timing is at or after the current display timing of the own projector 10′) (NO in step S71), the own projector 10′ instructs the display unit 24 to move to the designated reproduction timing in step S74 and to wait until the designated reproduction time in step S75.

Next, after the process in step S73 or S75, the own projector 10′ causes the display unit 24 to perform the reproduction in step S76.

According to the reproduction process of the case in which the reproduction timing is designated, the reproduction process of the own projector 10′ can be executed in synchronization with the other projector 10′ by determining whether the designated reproduction timing precedes the current display timing of the own projector 10′.

### Conceptual Diagram of a Fast-Forwarding Reproduction Process

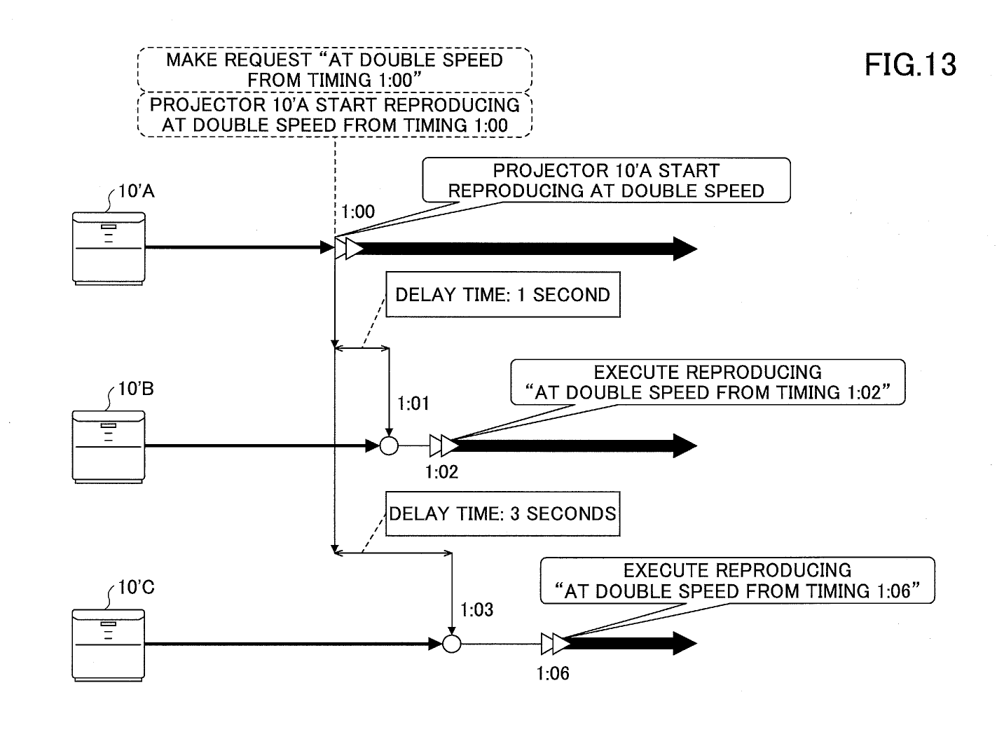

FIG. 13 is a conceptual diagram of the fast-forwarding reproduction process according to the second embodiment. In the example shown in FIG. 13, in a case in which the projector 10′ transmits, to the projectors 10′B and 10′C, fast-forwarding requests in which the reproduction timing is designated, the projectors 10′B and 10′C are controlled to compare the designated reproduction timing with the own current display timing.

As shown in FIG. 13, in response to receiving, from the user, the fast-forwarding request for fast-forwarding the moving images “at double speed from the timing 1:00” when reproducing the moving image, the projector 10′A causes the display request generation unit 21A to transmit, to each of the projectors 10′B and 10′C, the fast-forwarding reproduction request (“at double speed from the timing 1:00”) in which the reproduction timing is designated. Further, the projector 10′A starts reproducing at double speed from the timing 1:00.

In response to receiving the fast-forwarding request from the projector 10′A, the projector 10′B confirms the current display timing of the projector 10′B (1:01) when the request is received from the display control unit 22B. In this case, the communication time (delay time) between the projector 10′B and the projector 10′A is “1 second”.

Because the request is for reproducing at double speed and the current reproduction timing of the own projector 10′B is “1:01”, the projector 10′B calculates the current reproduction timing of the projector 10′A as “1:02”. Thus, the projector 10′B executes reproducing “at double speed from timing 1:02”.

Similarly, in response to receiving the fast-forwarding request from the projector 10′A, the projector 10′C confirms the current display timing of the projector 10′C (1:03) when the request is received from the display control unit 22C. In this case, the communication time (delay time) between the projector 10′C and the projector 10′A is “3 seconds”.

Because the request is for reproducing at double speed and the current reproduction timing of the own projector 10′C is “1:03”, the projector 10′C calculates the current reproduction timing of the projector 10′A as “1:06”. Thus, the projector 10′C executes reproducing “at double speed from timing 1:06”.

As described above, the projectors 10′B and 10′C, which have received the reproduction requests in which the reproduction timing is designated, calculate the current reproduction timing of the projector 10′A, which has transmitted the reproduction requests for changing the reproduction status from the designated reproduction timing, to reproduce the moving images synchronously at the calculated current reproduction timing.

### Conceptual Diagram of a Temporary Stopping Process using a Playlist

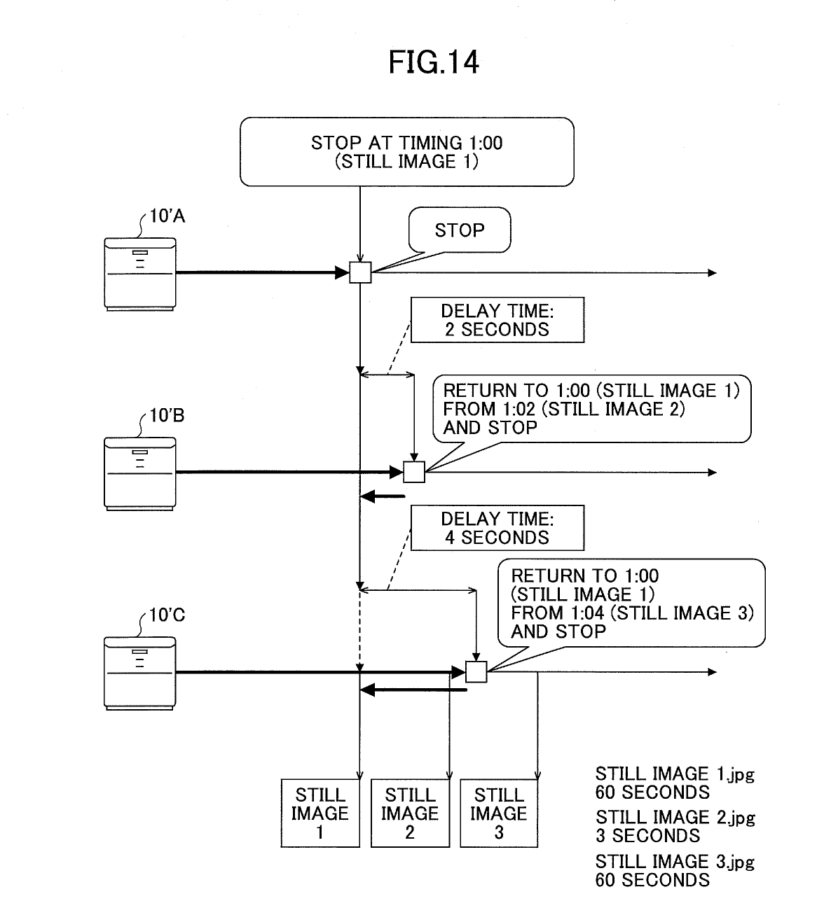

FIG. 14 is a conceptual diagram of the temporary stopping process using a playlist according to the second embodiment. In the example shown in FIG. 14 the projector 10′ previously stores a playlist of a plurality of contents and their display timings (times), and switches the contents (still image) being displayed after temporarily stopping the contents according to the playlist. The playlist may be a predetermined playlist set previously.

As shown in FIG. 14, in response to receiving the temporary stopping request from the user, the projector 10′A causes the display request generation unit 21A to confirm the display timing of the moving image (current display timing is “1:00 (still image 1)”) when the temporary stopping request is received. Further, the projector 10′A transmits, to each of the projectors 10′B and 10′C, the temporary stopping request which includes information of the temporary stopping timing “1:00 (still image 1)”.

In response to receiving the temporary stopping request from the projector 10′A, the projector 10′B confirms that the delay time (communication time) with the projector 10′A is “2 seconds” and “1:02 (still image 2)” is currently displayed in the projector 10′B. Thus, the projector 10′B returns to the temporary stopping timing “1:00 (still image 1)”, which is included in the temporary stopping request, and stops.

Similarly, in response to receiving the temporary stopping request from the projector 10′A, the projector 10′C confirms that the delay time (communication time) with the projector 10′A is “4 seconds” and “1:04 (still image 3)” is currently displayed in the projector 10′C. Thus, the projector 10′C returns to the temporary stopping timing “1:00 (still image 1)”, which is included in the temporary stopping request, and stops. It should be noted that the projector 10′ may use an internal timer to control the time in the display control based on the above described playlist.

Further, although the projectors 10′B and 10′C return to the temporary stopping timing based on the playlist in the above described temporary stopping process, the present invention is not limited to this. For example, in a case in which the temporary stopping request about the moving images being reproduced is received, the projectors 10′B and 10′C may stop the moving images after rewinding the moving images from the respective current display timings to the temporary stopping timing designated by the projector 10′A. In this way, the moving images can be stopped temporarily at the time instructed by the user.

### Conceptual Diagram of a Stopping Process

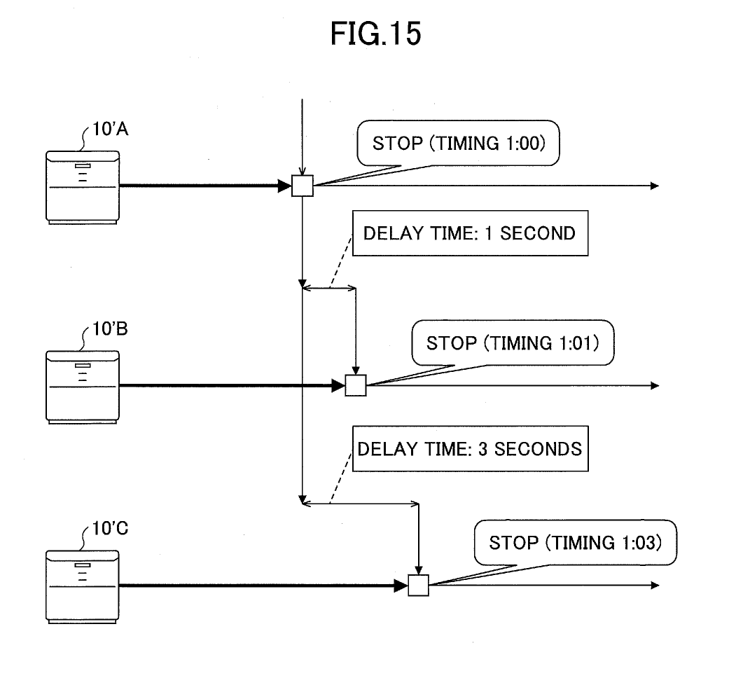

FIG. 15 is a conceptual diagram of the stopping process according to the second embodiment. FIG. 15 shows the example in which in response to receiving, from the user, a stopping request for stopping the moving images, the projector 10′A transmits the stopping requests to the projectors 10′B and 10′C.

As shown in FIG. 15, in response to receiving the stopping request from the user at “timing 1:00”, the projector 10′A causes the display request generation unit 21A to transmit the stopping request to each of the projectors 10′B and 10′C. Normally, in a case in which the moving images have been stopped, the stopped moving images are reproduced (restarted) from the start of the moving images. That is, because stopping the moving images does not require information of the reproduction timing of the moving images, the stopping request can be performed without including (designating) the information of the reproduction timing of the moving images.

### List of Timing Information

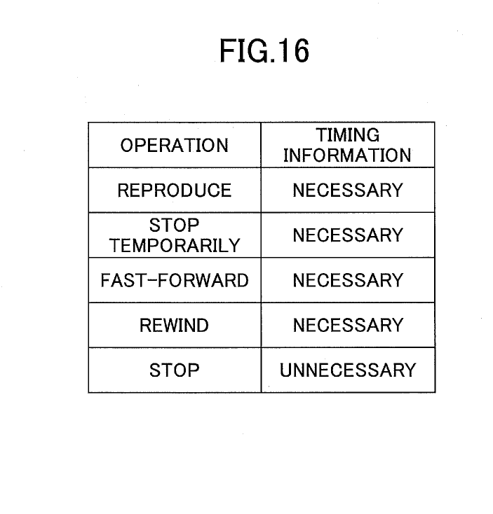

FIG. 16 is a list of timing information. The list of the timing information shown in FIG. 16 includes data items such as “OPERATION” and

“NECESSARY/UNNECESSARY OF TIMING INFORMATION”. The “OPERATION” includes, for example, “REPRODUCE”, “STOP TEMPORARILY” “FAST-FORWARD”, “REWIND”, and “STOP”. Further, “NECESSARY” or “UNNECESSARY” is set for the respective operations.

With reference to the above described list of the timing information, the display request generation unit 21 of the projector 10′ determines whether timing information (control timing for controlling the content such as the temporary stopping timing and the reproduction timing) should be included for respective display requests. In other words, the display request generation unit 21 can generate a display request which includes information of the display timing of the content, and a display request which does not include the information of the display timing of the content.

As described above, in the case in which the operation to “stop” the moving images is received from the user, the stopping request only for stopping the moving images is made to each of the projectors 10′ without including the timing information (reproduction timing) because the stopped moving images are reproduced (restarted) from the start of the moving images.

According to the above described embodiments, the displayed contents can be controlled synchronously.

Further, the present invention is not limited to these embodiments, but various variations and modifications may be made without departing from the scope of the present invention.

What is claimed is:

1. A display control apparatus connected to another display control apparatus comprising:
a display unit configured to display a content;
a request reception unit configured to receive a request about the content displayed by the display unit;
a display request generation unit configured to generate a plurality of display requests for controlling, in synchronization with each other, display statuses of contents displayed by the display control apparatus and the other display control apparatus in response to the request received by the request reception unit, the plurality of display requests including a first display request for controlling the display status of the content displayed by the other display control apparatus and a second display request for controlling the display status of the content displayed by the display control apparatus;
a communication unit configured to transmit the first display request to the other display control apparatus; and
a display control unit configured to control the display status of the content displayed by the display unit based on the second display request.

2. The display control apparatus according to claim 1,
wherein the first display request includes information of display timing for controlling the display status of the content displayed by the other display control apparatus, and
wherein the second display request includes information of display timing for controlling the display status of the content displayed by the display unit.

3. The display control apparatus according to claim 1, wherein the display request generation unit is configured to control timings of outputting the first display request and the second display request based on communication time required for communicating with the other display control apparatus.

4. The display control apparatus according to claim 3,
wherein the other display control apparatus includes one or more display control apparatuses connected to the display control apparatus, and
wherein the display request generation unit is configured to calculate display timing of the content or to control the timings of outputting the first display request and the second display request based on a longest communication time among communication times required for communicating with the one or more display control apparatuses.

5. The display control apparatus according to claim 2, wherein the display control unit is configured to control the display status of the content displayed by the display unit based on the display timing of the content.

6. The display control apparatus according to claim 1, wherein the display control unit is configured to control the display status of the content based on a predetermined playlist.

7. The display control apparatus according to claim 1, wherein the display request generation unit is configured to generate a third display request for controlling the display status of the content displayed by the other display control apparatus and a fourth display request for controlling the display status of the content displayed by the display control apparatus, the third display request and the fourth display request not including information of display timing of the content.

8. A display control system comprising:
a display control apparatus; and
another display control apparatus connected to the display control apparatus via a network,
wherein the display control apparatus includes a display unit configured to display a content, a request reception unit configured to receive a request about the content displayed by the display unit, a display request generation unit configured to generate a plurality of display requests for controlling, in synchronization with each other, display statuses of contents displayed by the display control apparatus and the other display control apparatus in response to the request received by the request reception unit, the plurality of display requests including a first display request for controlling the display status of the content displayed by the other display control apparatus and a second display request for controlling the display status of the content displayed by the display control apparatus, a communication unit configured to transmit the first display request to the other display control apparatus, and a display control unit configured to control the display status of the content displayed by the display unit based on the second display request, and
wherein the other display control apparatus includes another display unit configured to display the content, another communication unit configured to receive the first display request from the display control apparatus, and another display control unit configured to control the display status of the content displayed by the other display unit based on the first display request.

9. A display control method for controlling a display control apparatus and another display control apparatus connected to the display control apparatus, the display control method comprising:
a step of displaying a content in a display unit;
a step of receiving a request about the content displayed in the display unit;
a step of generating a plurality of display requests for controlling, in synchronization with each other, display statuses of contents displayed by the display control apparatus and the other display control apparatus in response to the request received in the request reception step, the plurality of display requests including a first display request for controlling the display status of the content displayed by the other display control apparatus and a second display request for controlling the display status of the content displayed by the display control apparatus;
a step of transmitting the first display request to the other display control apparatus; and
a step of controlling the display status of the content displayed in the display unit based on the second display request.

10. The display control method according to claim 9,
wherein the first display request includes information of display timing for controlling the display status of the content displayed by the other display control apparatus, and
wherein the second display request includes information of display timing for controlling the display status of the content displayed by the display control apparatus.

11. The display control method according to claim 9, wherein timings of outputting the first display request and the second display request are controlled in the step of generating based on communication time required for communicating with the other display control apparatus.

12. The display control method according to claim 11,
wherein the other display control apparatus includes one or more display control apparatuses connected to the display control apparatus, and
wherein display timing of the content is calculated or the timings of outputting the first display request and the second display request are controlled in the step of generating based on a longest communication time among communication times required for communicating with the one or more display control apparatuses.

13. The display control method according to claim 10, wherein the display status of the content displayed in the display unit is controlled in the step of controlling based on the display timing of the content.

14. The display control method according to claim 9, wherein the display status of the content is controlled in the step of controlling based on a predetermined playlist.

15. The display control method according to claim 9, wherein a third display request for controlling the display status of the content displayed by the other display control apparatus and a fourth display request for controlling the display status of the content displayed by the display control apparatus are generated in the step of generating, the third display request and the fourth display request not including information of display timing of the content.
